(19) United States
(12) Patent Application Publication
(10) Pub. No.: US 2024/0377134 A1
(43) Pub. Date: Nov. 14, 2024

(54) BELT DRYER

(71) Applicant: Rösler Holding GmbH, Bad Staffelstein (DE)

(72) Inventor: Rüdiger BÖHM, Untermerzbach (DE)

(21) Appl. No.: 18/651,999

(22) Filed: May 1, 2024

(30) Foreign Application Priority Data
May 8, 2023 (DE) 102023111904.4

(51) Int. Cl. F26B 15/18; F26B 3/04; F26B 21/02

(52) U.S. Cl. CPC F26B 15/18; F26B 3/04; F26B 21/02

(57) ABSTRACT

A belt dryer has a revolving transport belt that is guided through a pre-drying chamber and a main drying chamber, wherein a bypass channel is provided between these two chambers.

The present invention relates to a belt dryer for drying workpieces. Such belt dryers are known from the prior art and have a transport belt that is guided through a drying tunnel. In the drying tunnel, the workpieces are acted on by heated air to dry the workpieces when they pass through the drying tunnel.

It is the object of the present invention to provide a belt dryer of the initially mentioned kind with which a drying of workpieces that is gentle on the products can be achieved with a reduced energy consumption.

This object is satisfied by the features of claim 1 and in particular by a belt dryer that comprises a revolving transport belt that is guided through a pre-drying chamber and a main drying chamber. Furthermore, a drying device is provided that feeds heated and dehumidified air to the main drying chamber, wherein a bypass channel is provided between the main drying chamber and the pre-drying chamber, through which bypass channel air is guided from the main drying chamber into the pre-drying chamber.

With the dryer according to the invention, a low-temperature belt dryer is created with which considerable energy savings can be achieved since the workpieces are first subjected to a first drying step within the pre-drying chamber in that air led off from the main drying chamber is applied, in particular under pressure, to said workpieces in a pre-drying zone. A separate heating device can hereby be omitted in the region of the pre-drying chamber. Furthermore, since the air fed to the main drying chamber by the drying device is already heated and dehumidified, this air can be advantageously extracted from the main drying chamber and guided through the bypass channel into the pre-drying chamber without an additional energy input being required.

Advantageous embodiments of the invention are described in the description, in the drawing, and in the dependent claims.

According to a first advantageous embodiment, a pressure blower can be provided in the bypass channel, with which pressure blower air is drawn in from the main drying chamber, guided through the bypass channel and blown under pressure onto workpieces without additional heating within the pre-drying chamber in order to pre-dry and/or scoop the workpieces.

According to a further advantageous embodiment, the bypass channel can have at least one outlet that is arranged in the pre-drying chamber above the transport belt in order thereby to apply drying air to the workpieces from above. According to a further advantageous embodiment, the bypass channel can have at least one outlet that is arranged in the pre-drying chamber below or within the transport belt and in particular between the upper run and the lower run of the transport belt. In this embodiment, drying air can be applied to the workpieces from below to free them from liquid and pre-dry them. The outlet of the bypass channel can also be guided along the transport belt in the transport direction.

According to a further advantageous embodiment, the bypass channel can have at least one inlet that is positioned at the ceiling of the main drying chamber. In this way, the air with the highest temperature within the main drying chamber is extracted through the bypass channel. Alternatively or additionally, the inlet can also be arranged at the level of or below the transport belt in the vertical direction.

According to a further advantageous embodiment, an air outlet for air of the drying device can be arranged in the main drying chamber at the level of the transport belt so that the air supply into the main drying chamber (seen in a vertical section) takes place in the region of the workpieces or slightly below the workpieces.

Furthermore, it can be advantageous to provide the air inlet into the main drying chamber below the upper run or at the level of the lower run of the transport belt since this air can then flow through the transport belt from bottom to top, whereby the workpieces are dried particularly well.

According to a further advantageous embodiment, at least one blower, in particular a pressure blower, can be provided in the main drying chamber below the transport belt, draws in air there and outputs it via a flow channel into a region above the transport belt. In this embodiment, the air coming from the drying device is directed, on the one hand, from bottom to top through the transport belt and, on the other hand, onto the workpieces from above, in particular under pressure, in order to dry them gently and efficiently. For an efficient drying, it can be advantageous to provide two or even three such pressure blowers in the main drying chamber.

According to a further advantageous embodiment, the main drying chamber can directly adjoin the pre-drying chamber and can communicate therewith only via a passage opening through which the transport belt is guided. This ensures a spatial separation between the pre-drying chamber and the main drying chamber, wherein the inlet into the pre-drying chamber and the passage opening between the pre-drying chamber and the main drying chamber can additionally be closed by a strip curtain or similar to prevent heat and moisture from being discharged from the pre-drying chamber. The curtain can also be configured as a double curtain in which two spaced-apart curtains form an airlock.

According to a further advantageous embodiment, the inlet of the bypass channel can be positioned next to the passage opening, whereby the bypass channel can be dimensioned as short to minimize heat losses.

According to a further advantageous embodiment, the drying device can be integrated into an air circuit with which air is extracted from the main drying chamber and fed back into it heated and dehumidified. Considerable energy savings can be realized in a particularly advantageous manner by such a drying device.

It can furthermore be advantageous to apply air from the bypass channel under pressure to the workpieces in the pre-drying chamber from above and/or from below to free the workpieces from liquid. Depending on the application, a high-pressure or low-pressure compressor can be provided in the bypass channel for this purpose.

According to a further aspect, the present invention relates to a method for drying workpieces, for example using a belt dryer of the above-described kind, wherein the workpieces are placed on a transport belt that is guided through a pre-drying chamber and a main drying chamber, wherein heated and dehumidified air is fed to the main drying chamber by a drying device, and air is simultaneously extracted from the main drying chamber and guided into the pre-drying chamber.

According to a further advantageous embodiment, a particularly efficient drying of workpieces can be achieved in that at least three air circuits are generated in the belt dryer, namely a first air circuit with which air is extracted from the main drying chamber and fed back into it heated and dehumidified, a second air circuit with which air is extracted from the main drying chamber and output under pressure therein onto the workpieces, and a third air circuit with which air is extracted from the main drying chamber and output in the pre-drying chamber, in particular under pressure, onto the workpieces. With this advantageous procedure, the first air circuit is used for a low-temperature belt drying to condition the air within the main drying chamber, i.e. to dehumidify and heat it. The air of the first air circuit can be output into the main drying chamber with a comparatively low pressure, wherein it only has to be ensured that the drying device provides a sufficient air exchange within the main drying chamber. The second air circuit within the main drying chamber ensures that the heated and dehumidified air within the main drying chamber is output under pressure onto the workpieces. For this purpose, it can be advantageous if at least one, in particular two or three, pressure blowers are provided in the main drying chamber with which the air drawn in from the main drying chamber is output again at a comparatively high speed, for example in the order of approximately 20 to 30 m/s, and the delivered amount of air of these pressure blowers is in the order of approximately 4500 to 5500 m³/h.

Finally, the third air circuit is configured to use the heated and dehumidified air from the main drying chamber to pre-dry workpieces within the pre-drying chamber. For this pre-drying, no environmental air is thus used, but rather the already pre-conditioned air from the main drying chamber that can, for example, be output onto the workpieces in the pre-drying chamber by means of a pressure blower.

According to a further advantageous embodiment, the air of the first air circuit can be guided below the workpieces into the main drying chamber, wherein the air for the second air circuit can be extracted from the main drying chamber below the workpieces and can be output above the workpieces onto them again. On the one hand, this procedure ensures an advantageous circulation of the conditioned air within the main drying chamber. On the other hand, a good and efficient drying is achieved in that the air not only circulates within the main drying chamber, but is also output under pressure onto the workpieces.

According to a further advantageous embodiment, the air of the third air circuit can be extracted from the ceiling of the main drying chamber since the highest air temperature within the main drying chamber is present there. It can also be advantageous if this extraction of air takes place in the region of the inlet of the main drying chamber. Alternatively or additionally, the air of the third air circuit can also be extracted from the region into which the air of the first air circuit is fed.

A particularly energy-efficient and gentle procedure can be achieved by extracting air from the main drying chamber and feeding it back into the main drying chamber heated and dehumidified, with the maximum temperature of the fed air being 75° C., in particular 70° C. The energy consumption can be considerably reduced by such a comparatively low temperature of the dehumidified and heated air, wherein it is simultaneously ensured that the workpieces have such a low maximum temperature after passing through the belt dryer, for example a maximum of approximately 30 to 45° C., that they can be picked up and removed from the transport belt without prior cooling.

The present invention will be described in the following purely by way of example with reference to an advantageous embodiment and to the enclosed drawings. There are shown:

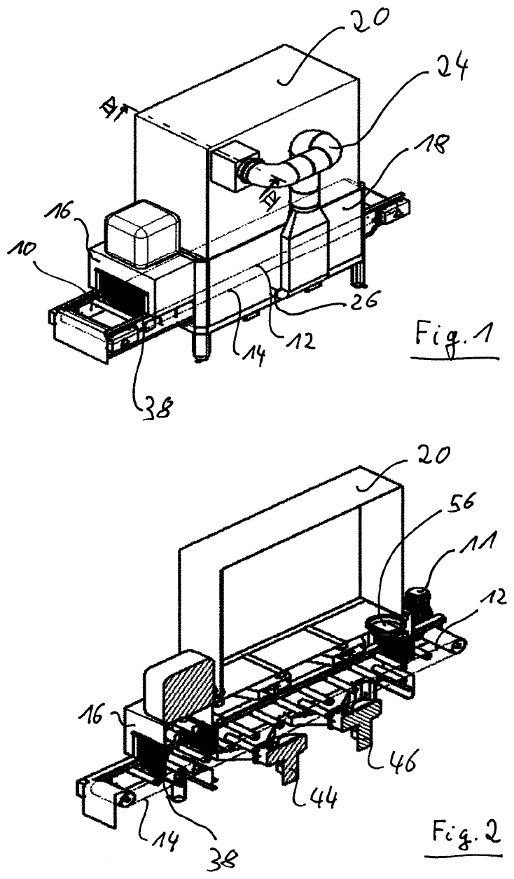

FIG. 1 a perspective view of a belt dryer;

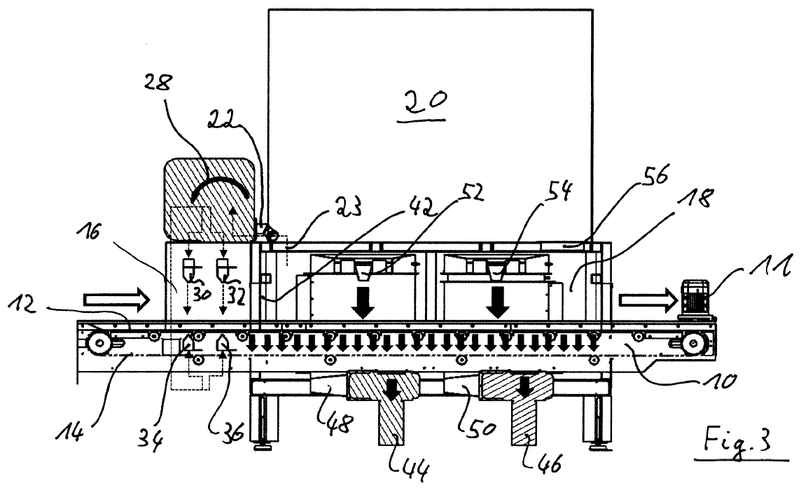

FIG. 2 a longitudinal section through the representation of FIG. 1;

FIG. 3 a plan view of the section of FIG. 2; and

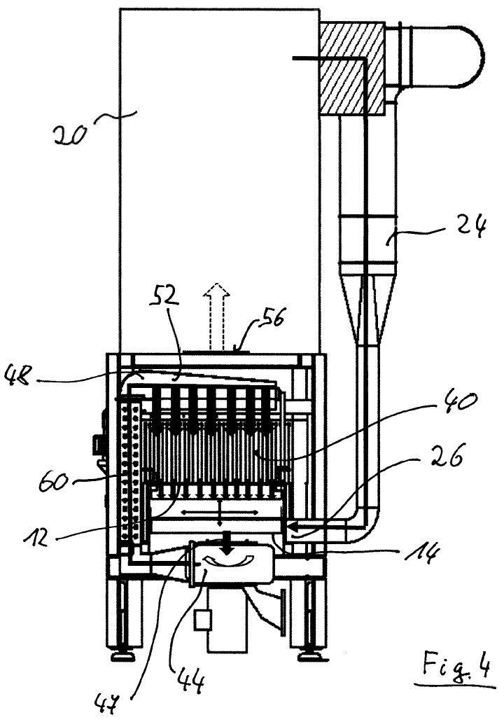

FIG. 4 a cross-section through the belt dryer of FIG. 1 along the line IV-IV.

The belt dryer shown in FIGS. 1 to 4 comprises a revolving transport belt 10 that has an upper run 12 and a lower run 14 and that is driven by a drive motor 11 (FIG. 2 and FIG. 3). The transport belt 10 is configured as permeable, for example as an articulated belt which is, for example, composed of stainless steel or plastic, and is guided through a pre-drying chamber 16 which is immediately adjoined by a main drying chamber 18. In the embodiment example shown, a drying device 20, which feeds heated and dehumidified air to the main drying chamber 18, is arranged above the main drying chamber 18 that is approximately four times as long as the pre-drying chamber 16. The maximum temperature of the fed air is approximately 70-75° C. and the air is fed into the main drying chamber via an air channel 24 (cf. FIG. 1 and FIG. 4) that has an air outlet 26 that, in the embodiment example shown, is arranged approximately at the level of the transport belt 10. In the embodiment example shown, the air inlet 26 is arranged below the upper run 12 approximately at the level of the lower run 14 and the air outlet 26 extends in the transport direction over a length that approximately corresponds to the length of the pre-drying chamber 16. The volume of the main drying chamber is at least two to three times as large as the volume of the pre-drying chamber.

As FIG. 3 illustrates, a bypass channel 22 is provided between the main drying chamber 18 and the pre-drying chamber 16, through which bypass channel 22 air is guided from the main drying chamber 18 into the pre-drying chamber 16. Above the pre-drying chamber 16, a blower 28, in particular a pressure blower, which is only schematically indicated by a round arrow, is in this respect provided with which air is extracted from the main drying chamber 18 and output through the bypass channel 22, in particular under pressure, into the pre-drying chamber 16. To achieve a good pre-drying, the bypass channel 22 in the embodiment shown has one or more outlets 30, 32 that are arranged in the pre-drying chamber 16 above the transport belt 10 and are configured as air knives, for example. Furthermore, the bypass channel 22 also opens into one or more lower outlets 34 and 36 that are arranged below the transport belt 10, and in particular between the upper run 12 and the lower run 14, so that the workpieces can also be acted on from below with the air guided through the bypass channel and can be pre-dried.

A single or double strip curtain 38 can be provided in the region of the inlet opening of the pre-drying chamber 16. Equally, such a strip curtain or also an air curtain can be provided in the transition region between the pre-drying chamber 16 and the main drying chamber 18. Finally, there is also a further strip curtain 40 in the region of the outlet opening of the main drying chamber 18 (FIG. 4).

FIG. 3 furthermore illustrates that the bypass channel 22 has an inlet 23 that is arranged at the ceiling of the main drying chamber 18. In the view of FIG. 3, the inlet 23 is also located next to the passage opening between the pre-drying chamber 16 and the main drying chamber 18.

It can also be seen from FIG. 3 that the pre-drying chamber 16 and the main drying chamber 18 directly adjoin one another and communicate with one another only via a passage opening 42 (FIG. 3) through which the transport belt 10 is guided.

To achieve a good drying of the workpieces in the main drying chamber 18, two pressure blowers 44 and 46 are arranged in the main drying chamber 18 below the transport belt 10 in the embodiment examples shown and draw in air in the direction of the arrow 47 of FIG. 4, i.e. in a vertical direction from above, that is blown in laterally by the drying device 20. Each pressure blower 44 and 46 is connected to a respective flow channel 48, 50, which opens above the transport belt 10, so that the air flow generated by the pressure blowers 48 and 50 is output downwardly onto the workpieces via an outlet formed as an air knife 52, 54, for example. The height of the outlets 52 and 54 can be adjusted depending on the situation to maximize the inflow pressure applied to the workpieces within the main drying chamber. Furthermore, a third pressure blower can also be provided that is configured in the same way as the pressure blowers 44 and 46 or that directs the air drawn in from the main drying chamber under pressure onto the lower side of the workpieces.

To achieve a continuous drying with good efficiency, the drying device 20, which can in particular be configured as a heat pump condensate dryer, is integrated into an air circuit with which the air is extracted from the main drying chamber 18 and fed back into it heated and dehumidified. The extraction of the air from the main drying chamber 18 takes place through an opening 56 provided at the ceiling and at the end of the main drying chamber 18. As the Figures illustrate, the drying device 20 and also the pressure blower 28 are arranged above the transport belt 10, wherein neither the drying device 20 nor the pressure blower 28 is wider than the transport belt 10. In this way, a very compact low-temperature belt dryer has been created.

It should be noted that, apart from the drying device 20, the above-described belt dryer does not need to have any further heating devices that would consume energy. However, it may take some time during the start-up of the belt dryer until the drying device 20 has reached its operating temperature. An electrical heating device 60 can, for example, be provided in one or both flow channels 48 and 50 or also in the drying device 20 exclusively for bridging this period and is only switched on for a limited duration, for example approximately 10-15 minutes, in the start-up mode.

The above-described belt dryer can, at its outer walls, be provided with housing insulation (not shown) that serves as both noise protection and thermal insulation. Within the belt dryer, sensors and control elements can be provided that are connected to a central control unit to be able to program various drying programs, belt speeds, temperatures and switch-on and switch-off intervals. A workpiece height control can further be provided at the infeed of the transport belt 10 and effects an automatic switching off of the transport belt if the workpieces are too high. Depending on the workpieces to be dried, the control unit can ensure that the belt speed and inflow velocities in the various air circuits are settable. For example, belt speeds of the transport belt can be set in a range from approximately 0.5 m/min up to approximately 3 m/min.

1. A belt dryer comprising a revolving transport belt that is guided through a pre-drying chamber and a main drying chamber, and a drying device that feeds heated and dehumidified air to the main drying chamber, wherein a bypass channel is provided between the main drying chamber and the pre-drying chamber, through which bypass channel air is guided from the main drying chamber into the pre-drying chamber.

2. The belt dryer according to claim 1,
wherein a pressure blower is provided in the bypass channel.

3. The belt dryer according to claim 1,
wherein the bypass channel has at least one outlet that is arranged in the pre-drying chamber above the transport belt.

4. The belt dryer according to claim 1,
wherein the bypass channel has at least one outlet that is arranged in the pre-drying chamber below or within the transport belt.

5. The belt dryer according to claim 1,
wherein the bypass channel has at least one inlet that is positioned at the ceiling of the main drying chamber.

6. The belt dryer according to claim 1,
wherein an air outlet for air of the drying device is arranged in the main drying chamber at the level of the transport belt.

7. The belt dryer according to claim 1,
wherein at least one pressure blower is provided in the main drying chamber below the transport belt, draws in air there and outputs it via a flow channel into a region above the transport belt.

8. The belt dryer according to claim 1,
wherein the pre-drying chamber and the main drying chamber directly adjoin one another and communicate with one another only via a passage opening through which the transport belt is guided.

9. The belt dryer according to claim 8,
wherein the bypass channel has at least one inlet that is positioned at the ceiling of the main drying chamber and the inlet of the bypass channel is positioned next to the passage opening.

10. The belt dryer according to claim 1,
wherein the drying device is integrated into an air circuit with which air is extracted from the main drying chamber and fed back into it heated and dehumidified.

11. A method for drying workpieces using a belt dryer, wherein
the workpieces are placed on a transport belt that is guided through a pre-drying chamber and a main drying chamber, wherein heated and dehumidified air is fed to the main drying chamber by a drying device, and air is simultaneously extracted from the main drying chamber and guided into the pre-drying chamber.

12. The method according to claim 11, wherein the belt dryer comprises the transport belt that is a revolving transport belt, that is guided through the pre-drying chamber and the main drying chamber, and the drying device wherein a bypass channel is provided between the main drying chamber and the pre-drying chamber, through which bypass channel said air is guided from the main drying chamber into the pre-drying chamber.

13. The method according to claim 11,
wherein at least three air circuits are generated in the belt dryer, namely a first air circuit with which air is extracted from the main drying chamber and fed back into it heated and dehumidified, a second air circuit with which air is extracted from the main drying chamber and output under pressure therein onto the workpieces, and a third air circuit with which air is extracted from the main drying chamber and output in the pre-drying chamber onto the workpieces.

14. The method according to claim 13,
wherein the air extracted with the third air circuit is output in the pre-drying chamber under pressure onto the workpieces.

15. The method according to claim 11,
wherein the air of the first air circuit is guided below the workpieces into the main drying chamber and, in the second air circuit, is extracted from the main drying chamber below the workpieces and is output above the workpieces onto them again.

16. The method according to claim 11,
wherein the air of the third air circuit is extracted from the ceiling of the main drying chamber.

17. The method according to claim 11,
wherein the air of the first air circuit having a maximum temperature of 75° C. is guided into the main drying chamber.
